(19) United States
(12) Patent Application Publication
(10) Pub. No.: US 2004/0071440 A1
(43) Pub. Date: Apr. 15, 2004

(54) Integrated circuit for signal input switching and recording and reproducing apparatus

(76) Inventor: Yukio Tsubokawa, Takefu-shi (JP)

Correspondence Address: REED SMITH LLP, Suite 1400, 3110 Fairview Park Drive, Falls Church, VA, 22042, US

(21) Appl. No.: 10/648,400

(22) Filed: Aug. 27, 2003

(30) Foreign Application Priority Data
Aug. 29, 2002 (JP) 2002-251374

(51) Int. Cl. H04N 5/76; H04N 5/781

(52) U.S. Cl. 386/46; 386/125

(57) ABSTRACT

It is an object of the present invention to provide an integrated circuit for signal input switching which can record a video or the like on a recording unit and can output the video or the like to a monitor unit, and can reduce a cross talk. An integrated circuit (20) for signal input switching is constituted as follows. The integrated circuit (20) comprises a recording input switching section (2), a monitor input switching section (3), and wirings for leading signals output from signal sources (21), (22), (31) and (32) to the recording input switching section (2) and the monitor input switching section (3). The recording input switching section (2) switches a connection of the signal sources (21), (22), (31) and (32) and a recording unit (26). The monitor input switching section (3) switches a connection of the signal sources (21), (22), (31) and (32) and a monitor unit (27). The recording input switching section (2), the monitor input switching section (3), and the wirings for leading the signals output from the signal sources to the recording input switching section (2) and the monitor input switching section (3) are provided in one package (1).

### BACKGROUND OF THE INVENTION

1. Field of the Invention

The present invention relates to an integrated circuit for signal input switching and a recording and reproducing apparatus which are used for recording and monitoring a video and a voice.

2. Description of the Related Art

A recording and reproducing apparatus can record a video and a voice and can cause a viewer to confirm the contents of the video and voice. More specifically, the recording and reproducing apparatus comprises a recording unit for recording a video and a voice (which will be hereinafter referred to as “a video or the like”) and a monitor unit for causing a viewer to confirm the video or the like.

In the recording and reproducing apparatus, a video signal and a voice signal which are output from a signal source such as a video are input to the recording unit and the video or the like is recorded, and the video signal or the like output from the signal source is input to the monitor unit and the video or the like is output to the monitor unit.

Moreover, the recording and reproducing apparatus is provided with a signal processing circuit for leading the video signal or the like output from the signal source to the recording unit and the monitor unit. The signal processing circuit has a part formed by an integrated circuit. Furthermore, some recording and reproducing apparatuses can record video signals or the like output from a plurality of signal sources on a recording unit and can output a video or the like to a monitor unit.

In the recording and reproducing apparatus capable of recording the video signals or the like from the signal sources, the signal sources to be connected to the recording unit and the monitor unit can be switched and any of the signal sources outputting the video or the like to be recorded can be selected properly.

In a circuit for leading the signals output from the signal sources to the recording unit and the monitor unit, the number of wirings is increased with an increase in the number of the signal sources. For this reason, if the recording operation of the recording unit or the like can be carried out for a large number of signal sources, a cross talk, that is, an interference between signals transmitted through each wiring is apt to be caused.

### SUMMARY OF THE INVENTION

It is an object of the present invention to provide an integrated circuit for signal input switching which can record a video or the like on a recording unit and can output the video or the like to a monitor unit, and can reduce a cross talk.

In order to attain the object, the present invention provides an integrated circuit for signal input switching comprising:

a recording input switching section for switching a connection of a plurality of signal sources outputting a video signal and/or a voice signal and a recording unit recording a video and/or a voice based on the signal(s) on a recording medium;

a monitor input switching section for switching a connection of the signal sources outputting a video signal and/or a voice signal and a monitor unit outputting a video and/or a voice based on the signal(s); and

a wiring for leading signals output from the signal sources to the recording input switching section and the monitor input switching section,

wherein the recording input switching section, the monitor input switching section and the wiring are provided in one package.

According to the integrated circuit for signal input switching in accordance with the present invention, the recording input switching section, the monitor input switching section and the wiring are provided in one package of the integrated circuit. Therefore, it is possible to prevent a cross talk between signals input from the signal source to the recording input switching section and the monitor input switching section through the wiring.

According to the integrated circuit for signal input switching in accordance with the present invention, moreover, the recording input switching section and the monitor input switching section are provided in one package. Therefore, a circuit for switching the signal source to be connected to the recording unit and the monitor unit can be small-sized.

Furthermore, it is possible to constitute a recording and reproducing apparatus comprising the integrated circuit for signal input switching, the signal sources, the recording unit and the monitor unit.

According to the recording and reproducing apparatus in accordance with the present invention, a circuit for leading a signal output from the signal source to the recording unit and the monitor unit and switching the signal source to be connected to the recording unit and the monitor unit is formed in the integrated circuit for signal input switching.

According to the recording and reproducing apparatus in accordance with the present invention, consequently, it is possible to prevent a cross talk between signals input from the signal source to the recording input switching section and the monitor input switching section. Consequently, it is possible to record a correct video having no disturbance or the like when recording the video or the like by the recording unit. When outputting the video or the like to the monitor unit, moreover, it is possible to output a correct video having no disturbance or the like.

According to the recording and reproducing apparatus in accordance with the present invention, furthermore, the circuit comprising the recording input switching section and the monitor input switching section can be small-sized. Consequently, the recording and reproducing apparatus can be small-sized.

Moreover, the integrated circuit for signal input switching can be provided with a signal processing section for carrying out a processing of demodulating a video signal and/or a voice signal which are/is input from the recording input switching section and converting the signal(s) into a recording signal(s), the signal processing section being provided in the one package.

According to the integrated circuit for signal input switching in accordance with the present invention, the signal processing section is provided in the package. Therefore, it is possible to prevent a cross talk for a signal to be processed by the signal processing section. Consequently, the signal processing section can accurately process a signal without causing a malfunction.

According to the integrated circuit for signal input switching in accordance with the present invention, furthermore, the signal processing section is provided in the package. Therefore, the whole structure including the circuit for carrying out the signal processing can be small-sized.

Moreover, it is possible to constitute the recording and reproducing apparatus comprising the integrated circuit for signal input switching including the signal processing section, the signal sources, the recording unit and the monitor unit.

According to the recording and reproducing apparatus in accordance with the present invention, consequently, it is possible to prevent a cross talk between signals input from the signal source to the recording input switching section and the monitor input switching section and a cross talk in the signal processing section. Thus, it is possible to record a correct video having no disturbance or the like when recording the video or the like by the recording unit. When outputting the video or the like to the monitor unit, moreover, it is possible to output a correct video having no disturbance or the like.

Moreover, the circuit comprising the recording input switching section, the monitor input switching section and the signal processing section can be small-sized. Thus, the recording and reproducing apparatus can be small-sized.

In the recording and reproducing apparatus, furthermore, the signal sources can include a tuner for receiving a television broadcast wave. According to the recording and reproducing apparatus in accordance with the present invention, consequently, the contents of a television broadcast received by the tuner can be recorded by the recording unit, and furthermore, can be output to the monitor unit.

In the recording and reproducing apparatus, moreover, the signal sources can include a digital reproducing unit having a recording medium for recording a video and/or a voice as digital data and serving to output a video signal and/or a voice signal based on a video and/or a voice which are/is recorded on the recording medium.

According to the recording and reproducing apparatus in accordance with the present invention, consequently, a video or the like output from the digital reproducing unit can be recorded by the recording unit, and furthermore, can be output to the monitor unit.

### BRIEF DESCRIPTION OF THE DRAWINGS

FIG. 1 is a block diagram showing an integrated circuit for signal input switching according to an embodiment of the present invention, and

FIG. 2 is a block diagram showing an integrated circuit for signal input switching according to another embodiment of the present invention.

### DESCRIPTION OF THE PREFERRED EMBODIMENTS

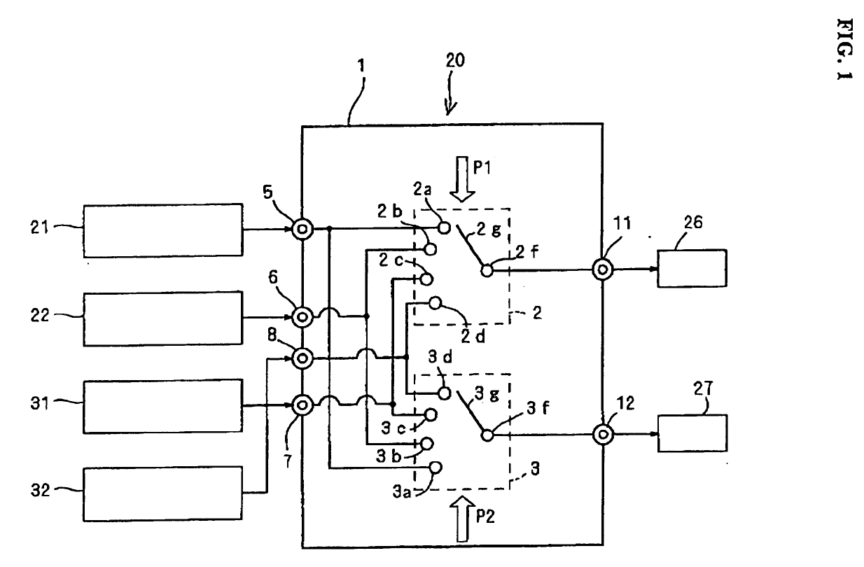

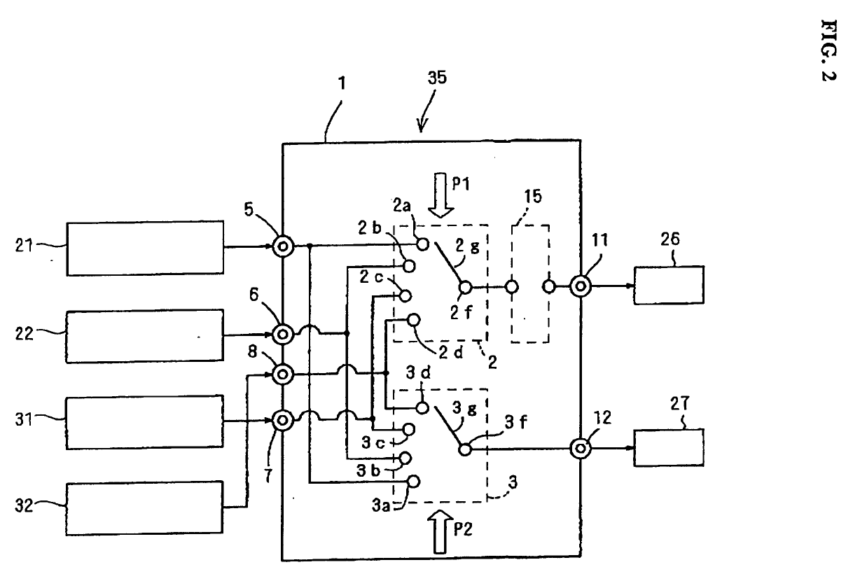

Embodiments of the present invention will be described with reference to FIGS. 1 and 2. FIG. 1 is a diagram showing the schematic structure of an integrated circuit 20 for signal input switching according to an embodiment of the present invention. FIG. 1 shows a block related to the signal processing of the integrated circuit 20 for signal input switching.

Moreover, FIG. 1 shows an example in which the integrated circuit 20 for signal input switching is incorporated in a part of a recording and reproducing apparatus capable of recording and reproducing a video and a voice. The recording and reproducing apparatus incorporating the integrated circuit 20 is constituted to also function as a television receiver.

The integrated circuit 20 for signal input switching comprises a package 1 in which a recording input switching section 2 and a monitor input switching section 3 are provided. The package 1 is the same as that used generally as a package for an integrated circuit and can be formed by silicon.

The recording input switching section 2 includes a first input contact 2a, a second input contact 2b, a third input contact 2c, a fourth input contact 2d, a first output contact 2f and switch means 2g.

Any of the input contacts 2a, 2b, 2c and 2d of the recording input switching section 2 to be connected to the output contact 2f is switched. The input contact to be connected to the output contact 2f is switched so that a signal source for recording a video or a voice by a recording unit 26 is switched.

The monitor input switching section 3 includes a fifth input contact 3a, a sixth input contact 3b, a seventh input contact 3c, an eighth input contact 3d, a second output contact 3f, and switch means 3g.

Any of the input contacts 3a, 3b, 3c and 3d of the monitor input switching section 3 to be connected to the output contact 3f is switched. The input contact 3a, 3b, 3c or 3d to be connected to the output contact 3f is switched so that a signal source for outputting a video and a voice to a monitor unit 27 is switched.

The input contact 2a, 2b or the like to be connected to the output contact 2f of the recording input switching section 2 is switched in response to a first switching control signal p1 transmitted from the outside of the package 1. The first switching control signal p1 includes data specifying any of the input contacts 2a, 2b and the like to be connected to the output contact 2f.

When the first switching control signal p1 is input to the recording input switching section 2, the switch means 2g conducts the output contact 2f to any of the input contacts 2a, 2b and the like which is specified by the signal p1.

Moreover, the input contact 3a, 3b or the like to be connected to the output contact 3f of the monitor input switching section 3 is switched in response to a second switching control signal p2. The second switching control signal p2 includes data specifying any of the input contacts 3a, 3b and the like to be connected to the output contact 3f.

When the second switching control signal p2 is input to the monitor input switching section 3, the switch means 3g conducts the output contact 3f to any of the input contacts 3a, 3b and the like which is specified by the signal p2.

The first switching control signal p1 and the second switching control signal p2 are output from a microcomputer for control (not shown) provided in the recording and reproducing apparatus. More specifically, the microcomputer for control outputs the control signal p1 corresponding to an operation for the recording and reproducing apparatus which is to be carried out by a viewer depending on the record of a video or the like through any signal source.

Moreover, the microcomputer for control outputs the control signal p2 corresponding to an operation for the recording and reproducing apparatus which is to be carried out by the viewer depending on the output of a video or the like through any signal source to the monitor unit 27.

The control signals p1 and p2 are input from control signal input terminals (not shown) provided in the package 1. The signals p1 and p2 are led to the recording input switching section 2 and the monitor input switching section 3 from the control signal input terminals by predetermined wirings (not shown) provided in the package 1, respectively.

The integrated circuit 20 is connected to the microcomputer for control through an I2C (INTER-INTEGRATED CIRCUIT) bus. In the case in which control is carried out by I2C bus communicating means, the control signal input terminals for inputting the signals p1 and p2 are provided to connect a clock line and a data line.

The first input contact 2a of the recording input switching section 2 and the fifth input contact 3a of the monitor input switching section 3 are conducted in the package 1, and the contacts 2a and 3a are connected to each other through a predetermined wiring in the package 1.

Moreover, the second input contact 2b of the recording input switching section 2 and the sixth input contact 3b of the monitor input switching section 3 are conducted in the package 1, and the contacts 2b and 3b are connected to each other through a predetermined wiring in the package 1.

Furthermore, the third input contact 2c of the recording input switching section 2 and the seventh input contact 3c of the monitor input switching section 3 are conducted in the package 1, and the contacts 2c and 3c are connected to each other through a predetermined wiring in the package 1.

Moreover, the fourth input contact 2d of the recording input switching section 2 and the eighth input contact 3d of the monitor input switching section 3 are conducted in the package 1, and the contacts 2d and 3d are connected to each other through a predetermined wiring in the package 1.

In addition, the integrated circuit 20 for signal input switching comprises a first signal input terminal 5, a second signal input terminal 6, a third signal input terminal 7 and a fourth signal input terminal 8. These signal input terminals 5 to 8 serve to input signals output from the signal sources.

The first signal input terminal 5 is connected to the first input contact 2a of the recording input switching section 2 and the fifth input contact 3a of the monitor input switching section 3, and is connected to the wiring connecting the contacts 2a and 3a in the package 1.

The second signal input terminal 6 is connected to the second input contact 2b of the recording input switching section 2 and the sixth input contact 3b of the monitor input switching section 3, and is connected to the wiring connecting the contacts 2b and 3b in the package 1.

The third signal input terminal 7 is connected to the third input contact 2c of the recording input switching section 2 and the seventh input contact 3c of the monitor input switching section 3, and is connected to the wiring connecting the contacts 2c and 3c in the package 1.

The fourth signal input terminal 8 is connected to the fourth input contact 2d of the recording input switching section 2 and the eighth input contact 3d of the monitor input switching section 3, and is connected to the wiring connecting the contacts 2d and 3d in the package 1.

Moreover, the first signal input terminal 5 is connected to a first tuner 21 to be a first signal source, and a video signal and/or a voice signal output from the tuner 21 are/is input to the first signal input terminal 5. The second signal input terminal 6 is connected to a second tuner 22 to be a second signal source, and a video signal and/or a voice signal output from the tuner 22 are/is input to the second signal input terminal 6.

The third signal input terminal 7 is connected to a first external input terminal (a front input terminal) of the recording and reproducing apparatus, and a video signal and/or a voice signal output from a third signal source 31 connected to the first external input terminal are/is input to the third signal input terminal 7. The third signal source 31 is present on the outside of the recording and reproducing apparatus provided with the integrated circuit 20.

The fourth signal input terminal 8 is connected to a second external input terminal (a rear input terminal) of the recording and reproducing apparatus, and a video signal and/or a voice signal output from a fourth signal source 32 connected to the second external input terminal are/is input to the third signal input terminal 8. The fourth signal source 32 is present on the outside of the recording and reproducing apparatus provided with the integrated circuit 20.

For the third signal source 31 and the fourth signal source 32, it is possible to use a digital reproducing unit which records a video and a voice as digital data on a recording medium and outputs video and voice signals representing a video and a voice recorded on the recording medium.

Specific examples of the digital reproducing unit include a CD/MD PLAYER (a compact disc/Mini Disk player), a DVD PLAYER (digital versatile disc player) and an HDD PLAYER (a hard disk player).

For the third signal source 31 and the fourth signal source 32, moreover, it is also possible to use a VCR (a video cassette recorder) and a VTR (videotape recorder) which utilize a magnetic tape as a recording medium and output video and voice signals representing a video and a voice to be recorded on the magnetic tape.

Moreover, the integrated circuit 20 for signal input switching includes a first signal output terminal 11 and a second signal output terminal 12. The first signal output terminal 11 and the second signal output terminal 12 serve to output, from the integrated circuit 20, a video signal or the like transmitted from the signal sources thereto.

The first signal output terminal 11 is connected to the output contact 2f in the package 1. Moreover, the first signal output terminal 11 is connected to a recording unit 26 on the outside of the package 1. Then, the video and voice signals transmitted from the signal source to the output contact 2f are input to the recording unit 26 through the first signal output terminal 11.

The second signal output terminal 12 is connected to the output contact 3f in the package 1. Moreover, the second signal output terminal 12 is connected to a monitor unit 27 on the outside of the package 1. Then, the video and voice signals transmitted from the signal source to the output contact 3f are input to the monitor unit 27 through the second signal output terminal 12.

The recording unit 26 records a video and a voice based on the input video and voice signals. The recording unit 26 includes a recording medium for recording a video and a voice. When the video and voice signals from the first signal output terminal 11 are input to the recording unit 26, the recording unit 26 records, on the recording medium, the video and the voice based on the video signal and the like.

Specific examples of the recording unit 26 include a CD/MD PLAYER (a compact disc/Mini Disk player), a DVD PLAYER (a digital versatile disc player), and an HDD PLAYER (a hard disk player) which record a video and a voice as digital data on a recording medium and output video and voice signals representing the video and voice recorded on the recording medium.

For the recording unit 26, moreover, it is also possible to use a VCR (a video cassette recorder) and a VTR (videotape recorder) which utilize a magnetic tape as a recording medium and output video and voice signals representing a video and a voice to be stored in the magnetic tape.

The monitor unit 27 outputs the video and voice based on the input video and voice signals. By the monitor unit 27, a viewer can confirm the contents of the video and voice. The monitor unit 27 is equivalent to a television monitor to project a video onto a cathode-ray tube, a speaker for outputting a voice based on a voice signal or the like.

In the integrated circuit 20 described above, a grounding conductor (not shown) is provided in the package 1. The grounding conductor is provided in a predetermined place along a wiring pattern connecting the contacts in the package 1. The grounding conductor in the package 1 can have the same potential as that of a ground on the outside of the package 1 through a grounding terminal of the package 1 which is not shown.

Description will be given to an example in which the integrated circuit 20 for signal input switching is operated. In the following, the description will be given to the case in which the integrated circuit 20 is incorporated to be operated in the recording and reproducing apparatus as shown in FIG. 1.

The power supply of the recording and reproducing apparatus incorporating the integrated circuit 20 is turned ON. Next, the recording and reproducing apparatus is operated to receive one television channel and to record it by the recording unit 26. Moreover, the recording and reproducing apparatus is operated to receive another television channel and to output the same television channel to the monitor unit 27.

Consequently, the receiving frequency of the first tuner 21 is set to receive the one television channel. Moreover, the receiving frequency of the second tuner 22 is set to receive the another television channel. Furthermore, the first switching control signal p1 and the second switching control signal p2 are output from the microcomputer for control.

The control signal p1 includes, in the contents, that the contact 2a is connected as the input contact to the output contact 2f of the recording input switching section 2. Moreover, the control signal p2 includes, in the contents, that the contact 3b is connected as the input contact to the output contact 3f of the monitor input switching section 3.

Thus, the switch means 2g conducts the contacts 2f and 2a in the recording input switching section 2. Furthermore, the switch means 3g conducts the contacts 3f and 3b in the monitor output switching section 3.

Consequently, the contents of the broadcast of one television channel received by the first tuner 21 are recorded by the recording unit 26, and the contents of the broadcast of another television channel received by the second tuner 22 are output to the monitor unit 27.

As described above, the contents of the broadcast received by the first television tuner 21 to be the first signal source are recorded by the recording unit 26 and the contents of the broadcast received by the second television tuner 22 to be the second signal source are output to the monitor unit 27. In addition, a video or the like based on a signal output from the second signal source 22 can be recorded by the recording unit 26 and a video or the like based on a signal output from the first signal source 21 can be output to the monitor unit 27.

Moreover, a video or the like based on a signal output from the third signal source 31 can be recorded by the recording unit 26 and a video or the like based on a signal output from the fourth signal source 32 can be output to the monitor unit 27.

More specifically, one of the signal sources 21, 22, 31 and 32 can be selected as a signal source for recording a video or the like by the recording unit 26, and one of the signal sources 21, 22, 31 and 32 can be selected as a signal source for outputting a video or the like by the monitor unit 27. Furthermore, the signal source for recording a video or the like by the recording unit 26 may be identical to the signal source for outputting a video or the like by the monitor unit 27.

According to the integrated circuit 20 for signal input switching described above, the recording input switching section 2 and the monitor input switching section 3 are incorporated in one package 1. The package 1 includes a wiring for connecting a contact provided in the recording input switching section 2 and a contact provided in the monitor input switching section 3.

Consequently, it is possible to prevent a cross talk, that is, an interference from being generated between a signal input to or output from the recording input switching section 2 and a signal input to or output from the monitor input switching section 3.

For example, the recording input switching section 2 can be provided in one integrated circuit and the monitor input switching section 3 can be provided in another integrated circuit. Each contact of the recording input switching section 2 and each contact of the monitor input switching section 3 can also be conducted by wirings provided on the outside of the one integrated circuit and the another integrated circuit. If a large number of wirings are provided on the outside of the integrated circuit, however, a cross talk is generated between the signals to be transmitted through the wirings, which is not preferable.

According to the integrated circuit 20 for signal input switching in accordance with the present invention, as described above, the recording input switching section 2 and the monitor input switching section 3 are provided in one package 1, and the wiring for connecting the contact of the recording input switching section 2 and the contact of the monitor input switching section 3 is provided in one package 1. Therefore, a cross talk can be prevented.

Moreover, the recording input switching section 2 and the monitor input switching section 3 are not provided in separate packages but one package. Consequently, a circuit for switching the signal sources to be connected to the recording unit 26 and the monitor unit 27 can be small-sized.

Next, another embodiment of the present invention will be described. FIG. 2 is a diagram showing the schematic structure of an integrated circuit 35 for signal input switching according to another embodiment of the present invention. FIG. 2 shows a block related to the signal processing of the integrated circuit 35 for signal input switching.

Moreover, FIG. 2 shows an example in which the integrated circuit 35 for signal input switching is incorporated in a part of a recording and reproducing apparatus capable of recording and reproducing a video and a voice. The recording and reproducing apparatus incorporating the integrated circuit 35 is constituted to also function as a television receiver.

The integrated circuit 35 for signal input switching shown in FIG. 2 comprises a signal processing section 15 in a package 1. In the integrated circuit 35, other members are constituted in the same manner as those of the integrated circuit 20 described with reference to FIG. 1 except that the signal processing section 15 is provided and the provision of the signal processing section 15 causes an output contact 2f of a recording input switching section 2 to be connected to the input terminal of the signal processing section 15 and causes a first signal output terminal 11 to be connected to the output terminal of the signal processing section 15.

The signal processing section 15 carries out a processing of demodulating a video signal and/or a voice signal which are/is input and converts the signal(s) into a recording signal(s). More specifically, when the video signal and/or the voice signal are/is input from the recording input switching section 2, the signal processing section 15 demodulates the signal to be a recording signal and outputs the recording signal to the first signal output terminal 11.

When the recording signal output to the first signal output terminal 11 is input to a recording unit 26, a video and a voice based on the signal are recorded by the recording unit 26.

For the signal processing section 15, it is possible to provide a component for carrying out a Y/C processing, that is, a processing of FM modulating a luminance signal (Y) and a low-pass conversion processing for a color signal (C), for example.

According to the integrated circuit 35 for signal input switching, the signal processing section 15 is provided in the package 1. Consequently, it is possible to prevent a cross talk for a signal to be processed by the signal processing section 15. More specifically, the signal processing section 15 is provided in the package 1 so that a large number of wiring patterns for leading a signal to the outside of the package 1 do not need to be provided. Consequently, the signal processing section 15 can accurately process a signal without causing a malfunction.

According to the integrated circuit 35 for signal input switching, moreover, the signal processing section 15 is provided in the package 1. Therefore, the whole structure including a circuit for carrying out a signal processing can be small-sized.

As described above, according to the present invention, the circuit having the recording input switching section and the monitor input switching section for switching the signal sources to be connected to the recording unit and the monitor unit is provided in one package of the integrated circuit. Therefore, it is possible to prevent a cross talk between the signals input to the recording input switching section and the monitor input switching section.

According to the present invention, moreover, the recording input switching section and the monitor input switching section are provided in one package of the integrated circuit. Therefore, the circuit for switching the signal sources to be connected to the recording unit and the monitor unit can be small-sized.

What is claimed is:

1. An integrated circuit for signal input switching comprising:
a recording input switching section for switching a connection of a plurality of signal sources outputting a video signal and/or a voice signal and a recording unit recording a video and/or a voice based on said signal on a recording medium;
a monitor input switching section for switching a connection of the signal sources outputting said video signal and/or said voice signal and a monitor unit outputting a video and/or a voice based on said signal; and
a wiring for leading signals output from said signal sources to said recording input switching section and said monitor input switching section,
wherein said recording input switching section, said monitor input switching section and said wiring are provided in one package.

2. The integrated circuit for signal input switching according to claim 1, further comprising a signal processing section for carrying out a processing of demodulating a video signal and/or a voice signal which are/is input from said recording input switching section and converting said signal(s) into a recording signal(s), the signal processing section being provided in the one package.

3. A recording and reproducing apparatus comprising:
a plurality of signal sources for outputting a video signal and/or a voice signal;
a recording unit for recording, on a recording medium, a video and/or a voice based on said video signal and/or said voice signal which are/is output from said signal sources;
a monitor unit for outputting a video and/or a voice based on the video signal and/or said voice signal which are/is output from said signal sources; and
an integrated circuit for signal input switching for switching said signal sources to be connected to said recording unit and said monitor unit,
wherein said integrated circuit for signal input switching includes a recording input switching section for switching said signal sources to be connected to said recording unit, a monitor input switching section for switching the signal sources to be connected to said monitor unit, and a wiring for leading said signals output from said signal sources to said recording input switching section and said monitor input switching section, and
said recording input switching section, said monitor input switching section and said wiring are provided in one package.

4. The recording and reproducing apparatus according to claim 3, wherein said integrated circuit for signal input switching includes a signal processing section for carrying out a processing of demodulating a video signal and/or a voice signal which are/is input from said recording input switching section and converting said signal(s) into a recording signal(s), said signal processing section being provided in the one package.

5. The recording and reproducing apparatus according to claim 3 or 4, wherein said signal sources include a tuner for receiving a television broadcast wave.

6. The recording and reproducing apparatus according to any of claims 3 to 5, wherein said signal sources include a digital reproducing unit having a recording medium for recording a video and/or a voice as digital data and serving to output a video signal and/or a voice signal based on said video and/or said voice which are/is recorded on said recording medium.
